(19) United States
(12) Patent Application Publication
(10) Pub. No.: US 2011/0043654 A1
(43) Pub. Date: Feb. 24, 2011

(54) IMAGE PROCESSING APPARATUS

(75) Inventor: Hideto Fujita, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 12/856,972

(22) Filed: Aug. 16, 2010

(30) Foreign Application Priority Data
Aug. 21, 2009 (JP) 2009-191618
Aug. 3, 2010 (JP) 2010-174114

(51) Int. Cl. H04N 5/228

(52) U.S. Cl. 348/222.1; 348/E05.031

(57) ABSTRACT

An image processing apparatus includes a capturer. A capturer captures an original image representing a scene. A first creator creates a first recorded image corresponding to a first cut-out area allocated to the scene, based on the original image captured by the capturer. A second creator creates a second recorded image corresponding to a second cut-out area having a size that falls below a size of the first cut-out area and being allocated to the scene, based on the original image captured by the capturer. A first outputter outputs a first display image corresponding to the first recorded image created by the first creator. A second outputter outputs depiction-range information indicating a depiction range of the second recorded image created by the second creator, in parallel with the output process of the first outputter.

### CROSS REFERENCE OF RELATED APPLICATION

The disclosure of Japanese Patent Application No. 2009-191618, which was filed on Aug. 21, 2009, and No. 2010-174114, which was filed on Aug. 3, 2010 are incorporated herein by reference.

### BACKGROUND OF THE INVENTION

1. Field of the Invention

The present invention relates to an image processing apparatus. More particularly, the present invention relates to an image processing apparatus which is applied to a digital video camera and which creates a plurality of object scene images representing a common object scene.

2. Description of the Related Art

According to one example of this type of apparatus, a video signal outputted from a camera section is recorded into a tape cassette in a first compressing system, and at the same time, the video signal is recorded on a memory card in a second compressing system. A video based on the video signal outputted from the camera section is displayed on a liquid crystal monitor.

However, in a case where an angle of view (aspect ratio) differs between the video recorded in the tape cassette and the video recorded on the memory card, an object appearing in one video disappears from the other video. As a result, it is probable that operability is deteriorated.

Furthermore, in the above-described apparatus, a so-called transcoding in which after the video signal in the first compressing system is recorded in the tape cassette, the compressing system for this video signal is converted into the second compressing system, and the converted video signal is recorded on the memory card is not executed.

### SUMMARY OF THE INVENTION

An image processing apparatus according to the present invention comprises: a capturer which captures an original image representing a scene; a first creator which creates a first recorded image corresponding to a first cut-out area allocated to the scene based on the original image captured by the capturer; a second creator which creates based on the original image captured by the capturer a second recorded image corresponding to a second cut-out area having a size that falls below a size of the first cut-out area and being allocated to the scene; a first outputter which outputs a first display image corresponding to the first recorded image created by the first creator; and a second outputter which outputs depiction-range information indicating a depiction range of the second recorded image created by the second creator, in parallel with the output process of the first outputter.

An image processing apparatus according to the present invention comprises: a reproducer which reproduces a first recorded image having a first angle of view from a recording medium; a definer which defines on the first recorded image reproduced by the reproducer a cut-out area corresponding to a second angle of view; a recorder which records a second recorded image belonging to the cut-out area defined by the definer onto the recording medium; a first outputter which outputs the first display image corresponding to the first recorded image reproduced by the reproducer; and a second outputter which outputs depiction-range information indicating a depiction range of the second recorded image recorded by the recorder, in parallel with the output process of the first outputter.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an allocation state of two cut-out areas in a raw image area of the SDRAM;

FIG. 5 is an illustrative view showing one example of a directory structure formed on a recording medium;

FIG. 6(A) is an illustrative view showing an aspect ratio of an image contained in an MP4 file;

FIG. 6(B) is an illustrative view showing an aspect ratio of an image contained in a 3GP file;

FIG. 7(A) is an illustrative view showing one example of position adjusting behavior of the cut-out area;

FIG. 7(B) is an illustrative view showing another example of the position adjusting behavior of the cut-out area;

FIG. 7(C) is an illustrative view showing still another example of the position adjusting behavior of the cut-out area;

FIG. 8(A) is an illustrative view showing one example of a display image;

FIG. 8(B) is an illustrative view showing another example of the display image;

FIG. 8(C) is an illustrative view showing still another example of the display image;

FIG. 9 is a block diagram showing one example of a configuration of an object detecting circuit applied to the embodiment in FIG. 2;

FIG. 10 is a flowchart showing one portion of behavior of a CPU applied to the embodiment in FIG. 2;

FIG. 11 is a flowchart showing another portion of the behavior of the CPU applied to the embodiment in FIG. 2;

FIG. 12 is a flowchart showing still another portion of the behavior of the CPU applied to the embodiment in FIG. 2;

FIG. 13 is a flowchart showing yet another portion of the behavior of the CPU applied to the embodiment in FIG. 2;

FIG. 14 is a block diagram showing one portion of another embodiment;

FIG. 15 is a flowchart showing one portion of behavior of the CPU applied to another embodiment;

FIG. 16 is an illustrative view showing one example of the display image in another embodiment;

FIG. 17 is a flowchart showing one portion of the behavior of the CPU applied to still another embodiment;

FIG. 18 is an illustrative view showing one example of the display image in still another embodiment;

FIG. 19 is a flowchart showing one portion of behavior of the CPU applied to yet another embodiment;

FIG. 20 is an illustrative view showing one example of the display image in yet another embodiment;

FIG. 21 is a block diagram showing a basic configuration of a further embodiment of the present invention;

FIG. 22 is a block diagram showing a configuration of a further embodiment of the present invention;

FIG. 23 is an illustrative view showing one example of a mapping state of an SDRAM applied to the embodiment in FIG. 22;

FIG. 24 is a flowchart showing one portion of behavior of the CPU applied to the embodiment in FIG. 22;

FIG. 25 is a flowchart showing another portion of the behavior of the CPU applied to the embodiment in FIG. 22;

FIG. 26 is a flowchart showing still another portion of the behavior of the CPU applied to the embodiment in FIG. 22;

FIG. 27 is a flowchart showing yet another portion of the behavior of the CPU applied to the embodiment in FIG. 22; and

FIG. 28 is a flowchart showing another portion of the behavior of the CPU applied to the embodiment in FIG. 22.

### DETAILED DESCRIPTION OF THE PREFERRED EMBODIMENTS

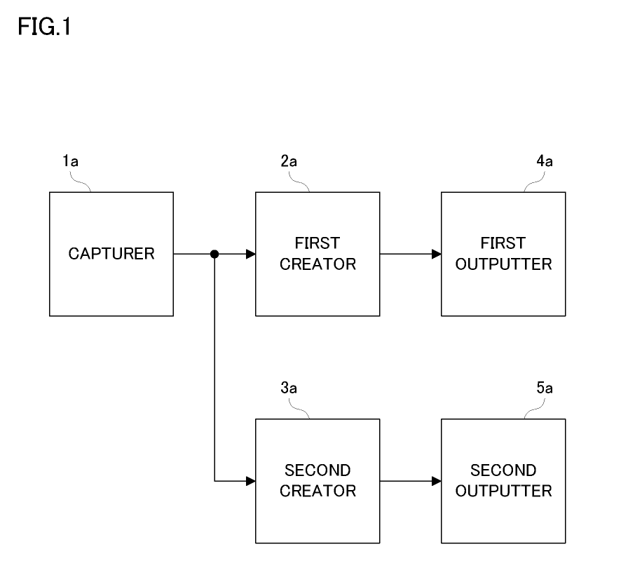

With reference to FIG. 1, an image processing apparatus of one embodiment of the present invention is basically configured as follows: A capturer 1a captures an original image representing a scene. A first creator 2a creates a first recorded image corresponding to a first cut-out area allocated to the scene, based on the original image captured by the capturer 1a. A second creator 3a creates a second recorded image corresponding to a second cut-out area having a size that falls below a size of the first cut-out area and being allocated to the scene, based on the original image captured by the capturer 1a. A first outputter 4a outputs a first display image corresponding to the first recorded image created by the first creator 2a. A second outputter 5a outputs depiction-range information indicating a depiction range of the second recorded image created by the second creator 3a, in parallel with the output process of the first outputter 4a.

Thus, the first recorded image corresponds to the first cut-out area, and the second recorded image corresponds to the second cut-out area smaller than the first cut-out area. The depiction-range information indicates the depiction range of the second recorded image and is outputted in parallel with the process for outputting the first display image corresponding to the first recorded image. This enables inhibition of a decrease in operability resulting from a difference in angle of view between the first recorded image and the second recorded image.

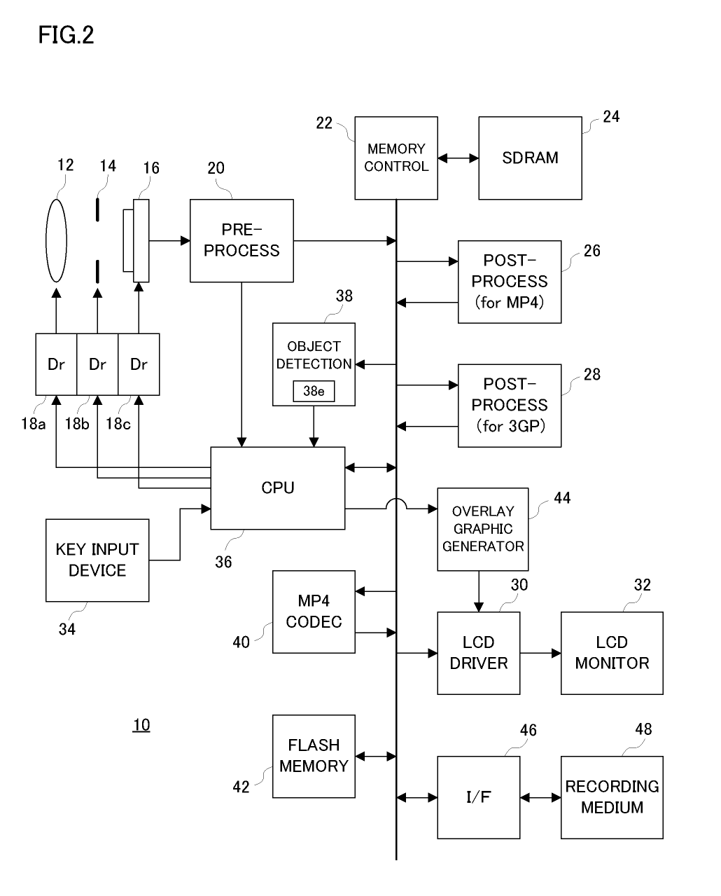

With reference to FIG. 2, a digital video camera 10 according to this embodiment includes a focus lens 12 and an aperture unit 14 respectively driven by drivers 18a and 18b. An optical image of an object scene enters, with irradiation, an imaging surface of an image sensor 16 through these members. It is noted that an effective image area on the imaging surface has a resolution of horizontal 2560 pixels×vertical 1600 pixels.

When a power source is applied, a CPU 36 starts up a driver 18c in order to execute a moving-image fetching process under an imaging task. In response to a vertical synchronization signal Vsync generated at every 1/60th of a second, the driver 18c exposes the imaging surface and reads out the electric charges produced on the imaging surface in a progressive scanning manner. From the image sensor 16, raw image data representing the object scene is outputted at a frame rate of 60 fps.

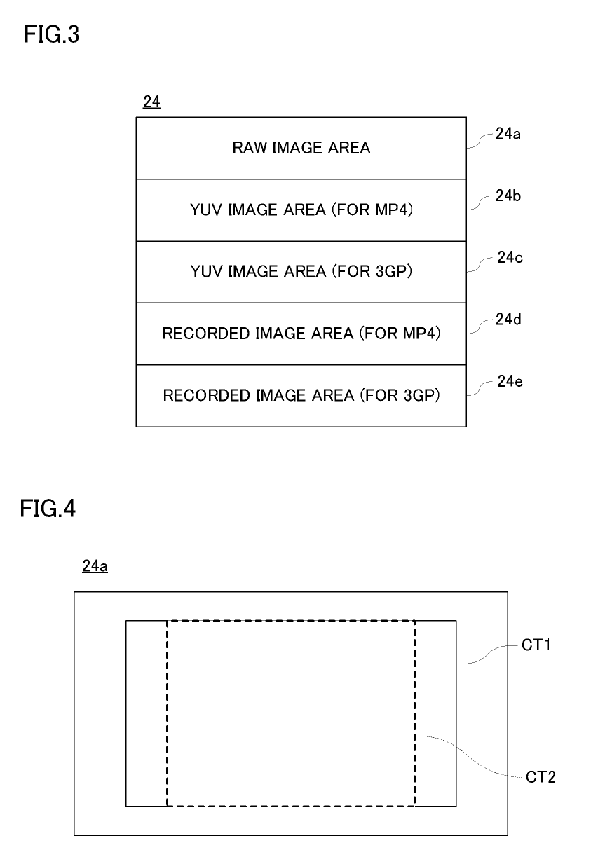

A pre-processing circuit 20 performs processes, such as digital clamp, pixel defect correction, and gain control, on the raw image data from the image sensor 16. The raw image data on which such pre-processes are performed is written into a raw image area 24a (see FIG. 3) of an SDRAM 24 through a memory control circuit 22.

With reference to FIG. 4, to the raw image area 24a, cut-out areas CT1 and CT2 are allocated. The cut-out area CT1 has a resolution (an aspect ratio is 16:9) equivalent to horizontal 1920 pixels×vertical 1080 pixels. On the other hand, the cut-out area CT2 has a resolution (an aspect ratio is 4:3) equivalent to horizontal 640 pixels×vertical 480 pixels.

A post-processing circuit 26 accesses the raw image area 24a through the memory control circuit 22 so as to read out the raw image data corresponding to the cut-out area CT1 at every 1/60th of a second in an interlace scanning manner. The read-out raw image data is subjected to processes such as color separation, white balance adjustment, YUV conversion, edge emphasis, and zoom operation. As a result, image data corresponding to a 1080/60i system is created. The created image data is written into a YUV image area 24b (see FIG. 3) of the SDRAM 24 through the memory control circuit 22.

An LCD driver 30 repeatedly reads out the image data accommodated in the YUV image area 24b, reduces the read-out image data so as to be adapted to a resolution of an LCD monitor 32, and drives the LCD monitor 32 based on the reduced image data. As a result, a real-time moving image (through image) representing the object scene is displayed on a monitor screen.

Moreover, the pre-processing circuit 20 simply converts the raw image data into Y data, and applies the converted Y data to the CPU 36. The CPU 36 performs an AE process on the Y data under an imaging-condition adjusting task so as to calculate an appropriate EV value. An aperture amount and an exposure time period defining the calculated appropriate EV value are set to the drivers 18b and 18c, respectively, and as a result, a brightness of the through image is moderately adjusted. Furthermore, the CPU 36 performs an AF process on a high-frequency component of the Y data when an AF start-up condition is satisfied. The focus lens 12 is placed at a focal point by the driver 18a, and as a result, a sharpness of the through image is continuously improved.

Furthermore, the CPU 36 executes a motion-detection process under a cut-out area control task 1 in order to detect a motion of the imaging surface in a direction perpendicular to an optical axis based on the Y data. The CPU 36 suspends a movement of the cut-out area CT1 when the detected motion is equivalent to pan/tilt movement of the imaging surface, and moves the cut-out area CT1 so that a camera shake of the imaging surface is compensated when the detected motion is equivalent to the camera shake. This inhibits a through-image movement resulting from the camera shake.

When a recording start operation is performed toward a key input device 34, the CPU 36 accesses a recording medium 48 through an I/F 46 under the imaging task so as to newly create an MP4 file and a 3GP file onto the recording medium 48 (the created MP4 file and 3GP file are opened).

To the MP4 file, a file name of SANY****.MP4 (**** is an identification number. The same applies hereinafter) is allocated. To the 3GP file, a file name of MOV****.3GP is allocated. Herein, to the MP4 file and the 3GP file that are simultaneously created, a common identification number is allocated. The MP4 file and the 3GP file that have a common object scene image are associated with each other by the identification number.

It is noted that the recording medium 48 has a directory structure shown in FIG. 5, and the MP4 file is managed under a directory DCIM while the 3GP file is managed under a directory SD_VIDEO.

Upon completion of the process for creating and opening the file, the CPU 36 starts up a post-processing circuit 28, an MP4 codec 40, and the I/F 46 under the imaging task in order to start a recording process.

The post-processing circuit 28 accesses the raw image area 24a through the memory control circuit 22 so as to read out the raw image data belonging to the cut-out area CT2 at every 1/30th of a second in an interlace scanning manner. The read-out raw image data is subjected to processes such as color separation, white balance adjustment, YUV conversion, edge emphasis, zoom operation. As a result, the image data corresponding to a 480/30i system is outputted from the post-processing circuit 28. The outputted image data is written into a YUV image area 24c (see FIG. 3) of the SDRAM 24 through the memory control circuit 22. It is noted that parameter values such as an edge emphasis degree differ between the post-processing circuits 26 and 28.

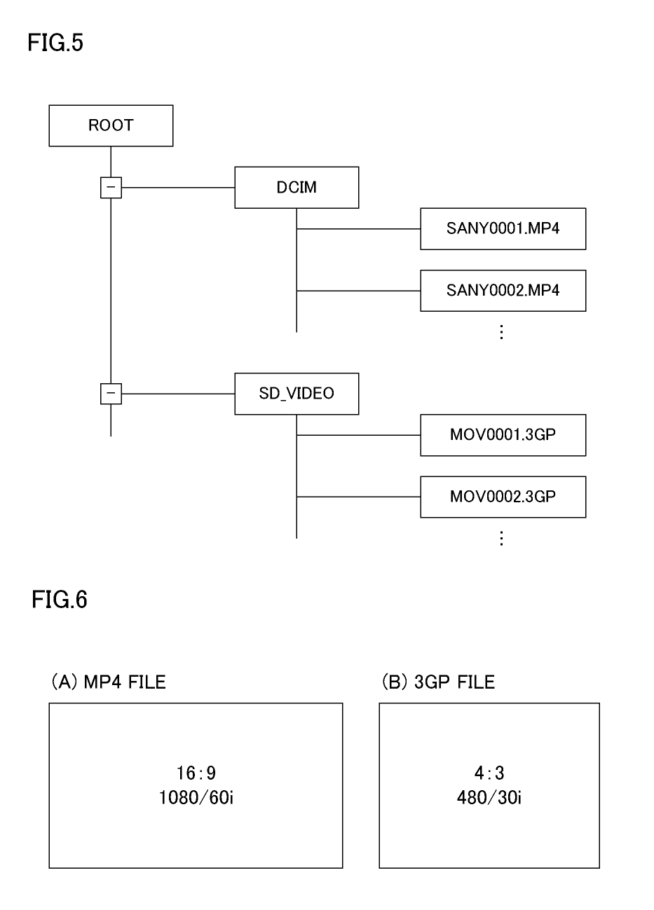

Therefore, after the recording process is started, the image data in the 1080/60i system that has the aspect ratio of 16:9 (see FIG. 6(A)) is accommodated in the YUV image area 24b, and at the same time, the image data in the 480/30i system that has the aspect ratio of 4:3 (see FIG. 6(B)) is accommodated in the YUV image area 24c.

The MP4 codec 40 reads out the image data accommodated in the YUV image area 24b through the memory control circuit 22, compresses the read-out image data according to an MPEG4 system, and writes the compressed image data into a recorded image area 24d (see FIG. 3) through the memory control circuit 22.

Furthermore, the MP4 codec 40 reads out the image data accommodated in the YUV image area 24c through the memory control circuit 22, compresses the read-out image data according to the MPEG4 system, and writes the compressed image data into a recorded image area 24e (see FIG. 3) through the memory control circuit 22.

The I/F 46 reads out the compressed image data accommodated in the recorded image area 24d through the memory control circuit 22, and writes the read-out compressed image data into the MP4 file newly created on the recording medium 48. Furthermore, the I/F 46 reads out the compressed image data accommodated in the recorded image area 24e through the memory control circuit 22, and writes the read-out compressed image data into the 3GP file newly created on the recording medium 48.

When a recording end operation is performed toward the key input device 34, the CPU 36 stops the post-processing circuit 28, the MP4 codec 40, and the I/F 46 in order to end the recording process. Subsequently, the CPU 36 accesses the recording medium 48 through the I/F 46 so as to close the MP4 file and the 3GP file that are writing destinations.

A position of the cut-out area CT2 is adjusted under a cut-out control task 2 in a period from the recording start operation to the recording end operation. In order to adjust the cut-out area CT2, the CPU 36 issues an object searching request toward an object detecting circuit 38 in response to the vertical synchronization signal Vsync.

The object detecting circuit 38 moves a checking frame that has each of “large size”, “intermediate size”, and “small size” from a head position of the object scene image (=image data in the 1080/60i system) accommodated in the YUV image area 24b toward a tail end position thereof in a raster scanning manner, checks one portion of an image belonging to the checking frame with a registered object (an object registered as a result of a previous operation), and registers a position and a size of the coincided object, as object information, on a register 38e. When the checking frame of the “small size” reaches the tail end position, a searching end notification is sent back from the object detecting circuit 38 to the CPU 36.

In response to the searching end notification sent back from the object detecting circuit 38, the CPU 36 determines whether or not it is successful to search the object that coincides with the registered object. If the object information is registered onto the register 38e, then it is determined that the searching is successful while if the object information is not registered onto the register 32e, then it is determined that the searching is failed.

When the searching is successful, the CPU 36 moves the cut-out area CT2 in so far as the cut-out area CT2 is not deviated from the cut-out area CT1 in order to capture the discovered object at a center. When the searching is failed, the CPU 36 moves the cut-out area CT2 in line with the movement of the cut-out area CT1.

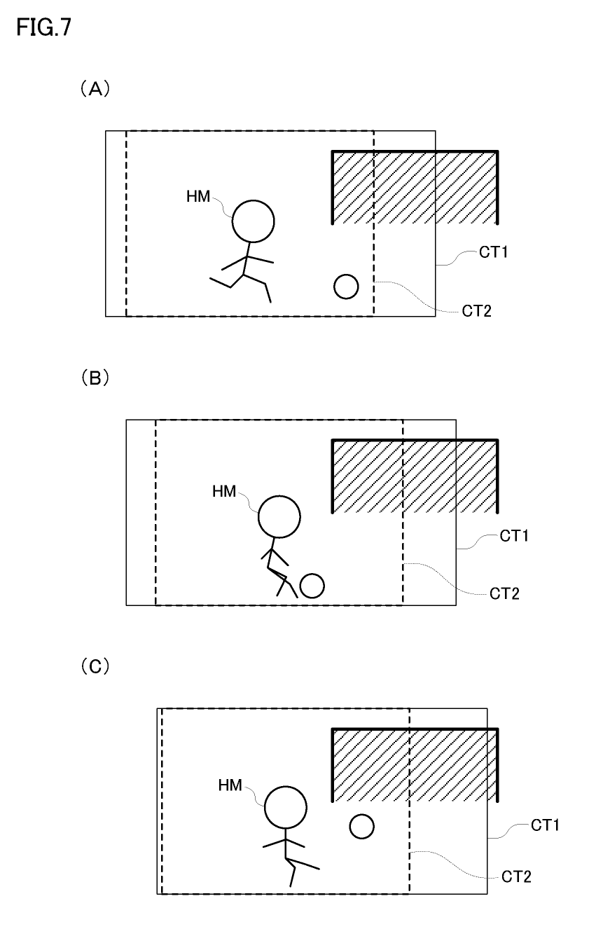

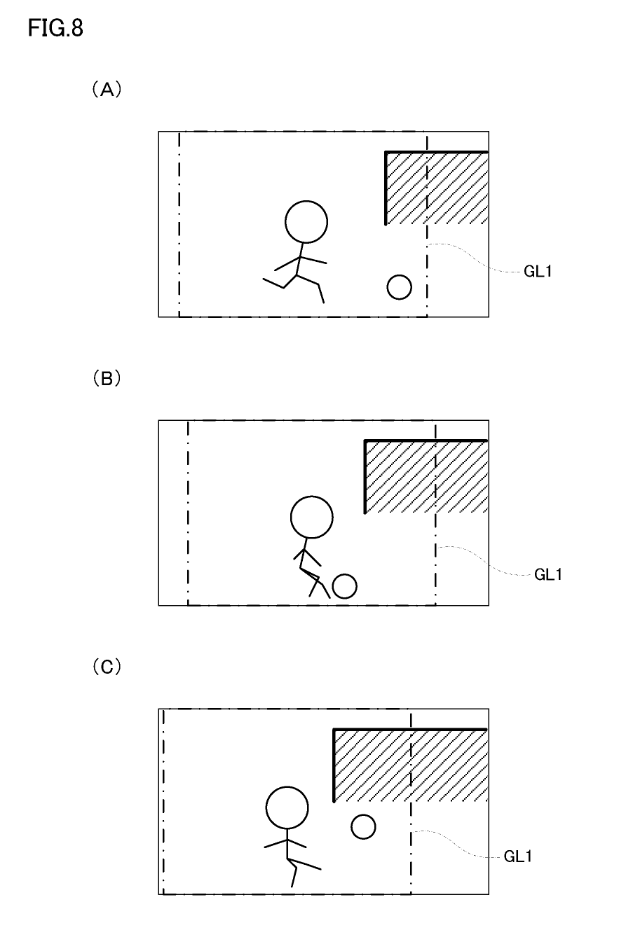

With reference to FIG. 7(A) to FIG. 7(C), in a case where a human HM is an object that coincides with the registered object and the cut-out area CT1 moves in a right direction by the pan/tilt movement of the imaging surface, the cut-out area CT2 moves in right and left directions relative to the cut-out area CT1 in order to capture the human HM at the center.

The CPU 36 sets the adjusted position of the cut-out area CT2 to an overlay graphic generator 44, and the overlay graphic generator 44 applies a graphic signal corresponding to the setting to the LCD driver 30. As a result, a guideline GL1 indicating the position of the cut-out area CT1 at a current time point is multiplexed onto the through image. Corresponding to pan/tilt movement shown in FIG. 7(A) to FIG. 7(C), displays of the through image and the guideline GL1 are transitioned as shown in FIG. 8(A) to FIG. 8(C).

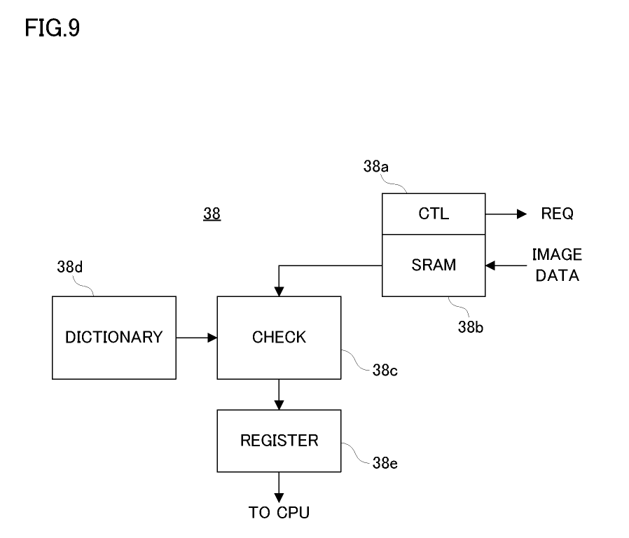

The object detecting circuit 38 is configured as shown in FIG. 9. A controller 38a assigns a rectangular checking frame to the YUV image area 24b, and reads out some of the image data belonging to the checking frame through the memory control circuit 22. The read-out image data is applied to a checking circuit 38c via an SRAM 38b.

A dictionary 38d contains a template representing the registered object image. The checking circuit 38c checks the image data applied from the SRAM 38b with the template contained in the dictionary 38d. When the template that coincides with the image data is discovered, the checking circuit 38c registers the object information in which the position and the size of the checking frame at the current time point are described, onto the register 38e.

The checking frame moves by each predetermined amount in a raster scanning manner, from the head position (an upper left position) toward the tail end position (a lower right position) of the YUV image area 24b. Furthermore, the size of the checking frame is updated at each time the checking frame reaches the tail end position in the order of “large size” to “intermediate size” to “small size”. When the checking frame of the “small size” reaches the tail end position, the searching end notification is sent back from the checking circuit 38c toward the CPU 36.

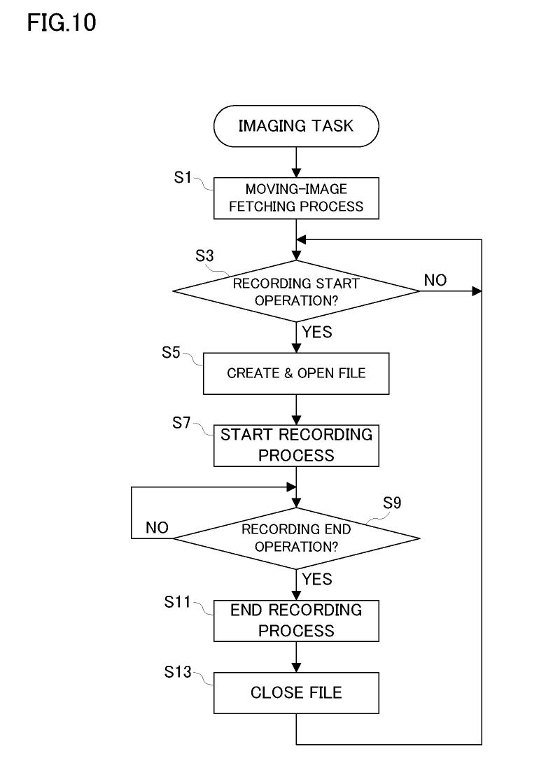

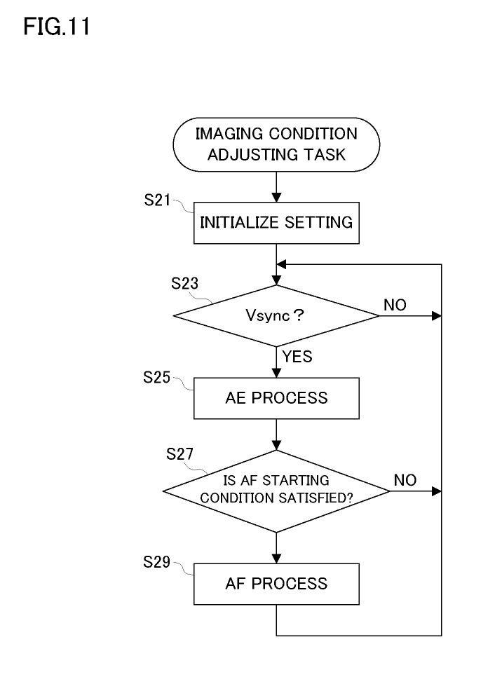

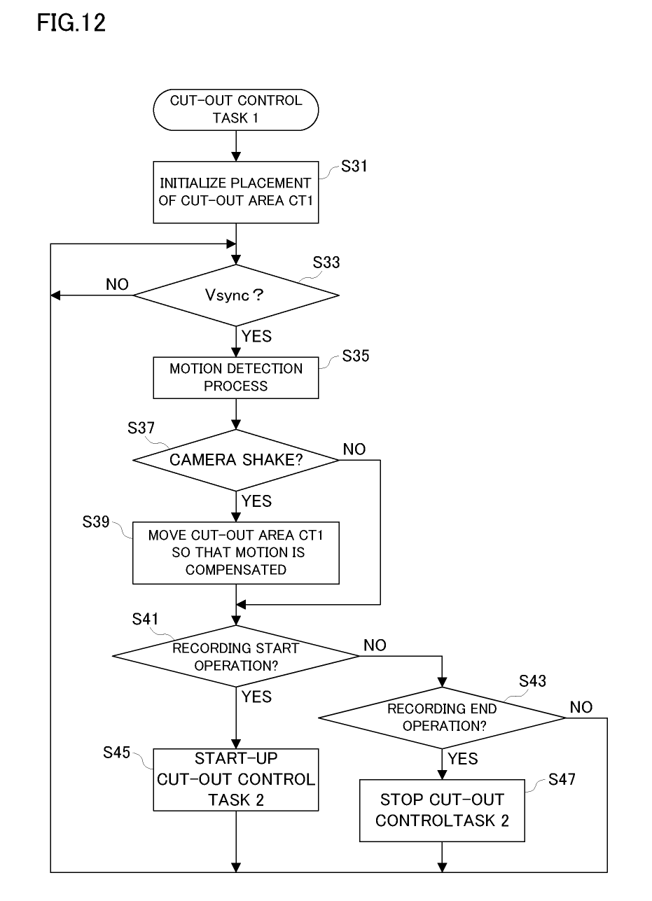

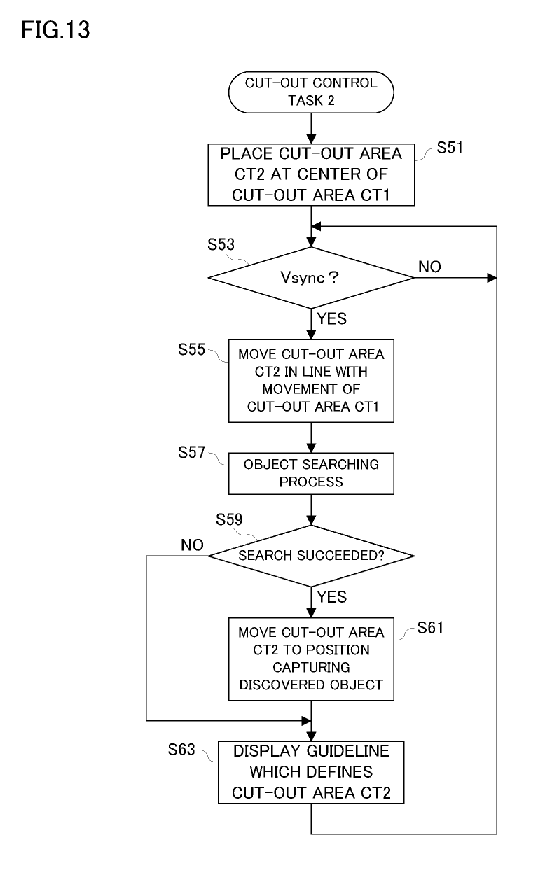

The CPU 36 performs a plurality of tasks including the imaging task shown in FIG. 10, the imaging condition adjusting task shown in FIG. 11, a cut-out control task 1 shown in FIG. 12, and a cut-out control task 2 shown in FIG. 13, in a parallel manner. It is noted that control programs corresponding to these tasks are stored in a flash memory 42.

With reference to FIG. 10, in a step S1, the moving-image fetching process is executed. Thereby, the through image is displayed on the LCD monitor 32. In a step S3, it is repeatedly determined whether or not the recording start operation is performed. When a determined result is updated from NO to YES, the process advances to a step S5. In the step S5, the recording medium 48 is accessed through the I/F 46 to newly create the MP4 file and the 3GP file that are in an opened state onto the recording medium 48. In a step S7, in order to start the recording process, the post-processing circuit 28, the MP4 codec 40, and the I/F 46 are started up.

The post-processing circuit 28 reads out some of the raw image data belonging to the cut-out area CT2 through the memory control circuit 22 so as to create the image data in the 480/30i system based on the read-out raw image data, and writes the created image data into the YUV image area 24c through the memory control circuit 22.

The MP4 codec 40 repeatedly reads out the image data in the 1080/60i system accommodated in the YUV image area 24b through the memory control circuit 22, compresses the read-out image data according to the MPEG4 system, and writes the compressed image data into the recorded image area 24d through the memory control circuit 22.

Moreover, the MP4 codec 40 repeatedly reads out the image data in the 480/30i system accommodated in the YUV image area 24c through the memory control circuit 22, compresses the read-out image data according to the MPEG4 system, and writes the compressed image data into the recorded image area 24e through the memory control circuit 22.

The I/F 46 reads out the compressed image data accommodated in the recorded image area 24d through the memory control circuit 22, and writes the read-out compressed image data into the MP4 file created in a step S9. Furthermore, the I/F 46 reads out the compressed image data accommodated in the recorded image area 24e through the memory control circuit 22, and writes the read-out compressed image data into the 3GP file created in the step S9.

In the step S9, it is determined whether or not the recording end operation is performed. When a determined result is updated from NO to YES, the process advances to a step S11 so as to stop the post-processing circuit 28, the MP4 codec 40, and the I/F 46 in order to end the recording process. In a step S13, the recording medium 48 is accessed through the I/F 46 so as to close the MP4 file and the 3GP file that are in the opened state. Upon completion of the file close, the process returns to the step S3.

With reference to FIG. 11, in a step S21, the focus, the aperture amount, and the exposure time period are initialized. In a step S23, it is determined whether or not the vertical synchronization signal Vsync is generated, and when a determined result is updated from NO to YES, the AE process is executed in a step S25. Thereby, a brightness of the through image is moderately adjusted. In a step S27, it is determined whether or not the AF start-up condition is satisfied, and if NO is determined, the process directly returns to the step S23 while if YES is determined, then the AF process is executed in a step S29, and then, the process returns to the step S23. As a result of the AF process, the focus lens 12 is placed at a focal point. Thereby, the sharpness of the through image is improved.

With reference to FIG. 12, in a step S31, the placement of the cut-out area CT1 is initialized. In a step S33, it is determined whether or not the vertical synchronization signal Vsync is generated. When a determined result is updated from NO to YES, the motion detection process in which the Y data is referred to is executed in a step S35. In a step S37, it is determined whether or not the motion of the imaging surface detected by the motion detection process is equivalent to the camera shake. When a determined result is NO, the process directly advances to a step S41 while when the determined result is YES, the process advances to the step S41 via a process in a step S39. In the step S39, the cut-out area CT1 is moved so that the detected motion of the imaging surface is compensated.

In the step S41, it is determined whether or not the recording start operation is performed, and in a step S43, it is determined whether or not the recording end operation is performed. When YES is determined in the step S41, the cut-out control task 2 is started up in a step S45. Thereafter, the process returns to the step S33. When YES is determined in the step S43, the cut-out control task 2 is stopped in a step S47. Thereafter, the process returns to the step S33. When NO is determined in the both steps S41 and S43, the process directly returns to the step S33.

With reference to FIG. 13, in a step S51, the cut-out area CT2 is placed at a center of the cut-out area CT1. In a step S53, it is determined whether or not the vertical synchronization signal Vsync is generated. When a determined result is updated from NO to YES, the process advances to a step S55 so as to move the cut-out area CT2 in line with the movement of the cut-out area CT1. In a subsequent step S57, the object searching request is issued toward the object detecting circuit 38 for a purpose of the object searching process.

The object detecting circuit 38 moves the checking frame that has each of the “large size”, the “intermediate size”, and the “small size” from the head position of the YUV image area 24b toward the tail end position thereof in a raster scanning manner, checks some of the image belonging to the checking frame with the registered object, and registers, as the object information, the position and the size of the registered object image detected thereby, onto the register 38e.

When the searching end notification is sent back from the object detecting circuit 38, it is determined in a step S59 whether or not it is successful to search the object that coincides with the registered object. Unless the object information is registered onto the register 38e, the process directly advances to a step S63, regarding that it is determined that the searching the coincided object is failed. On the other hand, if the object information is registered onto the register 38e, then the process advances to the step S63 via a process in a step S61, determining that the searching the coincided object is successful. In the step S61, in order to capture the discovered object at the center, the cut-out area CT2 is moved in so far as the cut-out area CT2 is not deviated from the cut-out area CT1.

In the step S63, the position of the cut-out area CT2 is set to the overlay graphic generator 44. As a result, the guideline GL1 indicating the position of the cut-out area CT2 is displayed on the LCD monitor 30 in an OSD manner. Upon completion of the process in the step S63, the process returns to the step S53.

As can be seen from the above-described explanation, the pre-processing circuit 20 fetches the raw image data outputted from the image sensor 16. The post-processing circuit 26 creates the image data corresponding to the cut-out area CT1 allocated to the object scene, based on the raw image data fetched by the pre-processing circuit 20. The post-processing circuit 28 creates the image data corresponding to the cut-out area CT2 having the size that falls below the size of the cut-out area CT1 and being allocated to the object scene, based on the raw image data fetched by the pre-processing circuit 20. On the LCD monitor 32, the through image that is based on the image data created by the post-processing circuit 26 is displayed. Moreover, the guideline GL1 indicating the position of the cut-out area CT2 is multiplexed onto the through image.

This enables inhibition of a decrease in operability resulting from the difference in angle of view between the image data created by the post-processing circuit 26 and the image data created by the post-processing circuit 28.

Furthermore, the object detecting circuit 38 searches the registered object from the cut-out area CT1, based on the raw image data fetched by the pre-processing circuit 20. The CPU 36 adjusts the position of the cut-out area CT2 so that the object detected by the object detecting circuit 38 is captured in the cut-out area CT2 (S61).

Therefore, when the object that coincides with the registered object appears in the object scene, an attribute of the cut-out area CT2 is adjusted so that the coincided object is captured in the cut-out area CT2. Thereby, it becomes possible to avoid a situation where the object appearing in the image corresponding to the cut-out area CT1 disappears from the image corresponding to the cut-out area CT2.

It is noted that in this embodiment, in order to show a structural outline of the object scene image recorded in the 3GP file, the guideline GL1 is multiplexed onto the through image. However, the through image that is based on the image data created by the post-processing circuit 28 may be optionally displayed on the LCD monitor 32 in parallel with the through image that is based on the image data created by the post-processing circuit 26.

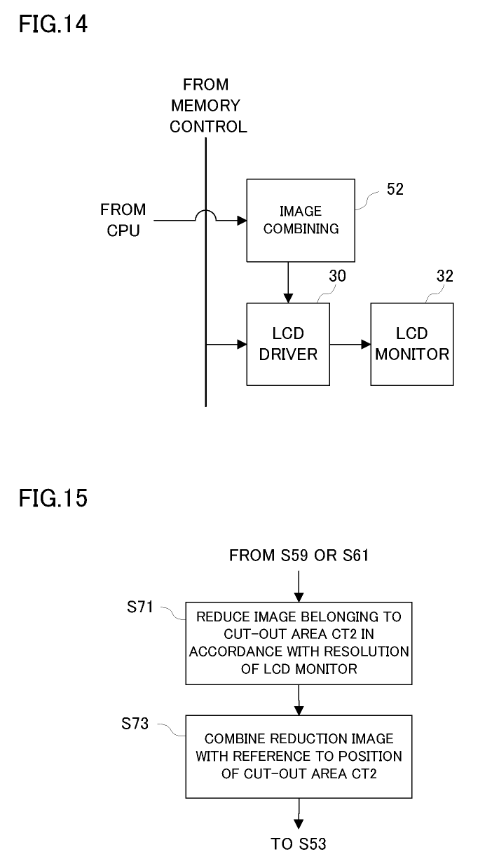

In this case, instead of the overlay graphic generator 44 shown in FIG. 2, an image combining circuit 52 shown in FIG. 14 is arranged. Moreover, the CPU 36 executes processes in steps S71 to S73 shown in FIG. 15 instead of the step S63 shown in FIG. 13.

With reference to FIG. 13, in the step S71, a reduction magnification corresponding to a difference between the resolution of the image data belonging to the cut-out area CT2 and the resolution of the LCD monitor 32 is set to the image combining circuit 52. Moreover, in the step S73, a position corresponding to a current position of the cut-out area CT2 is set to the image combining circuit 52.

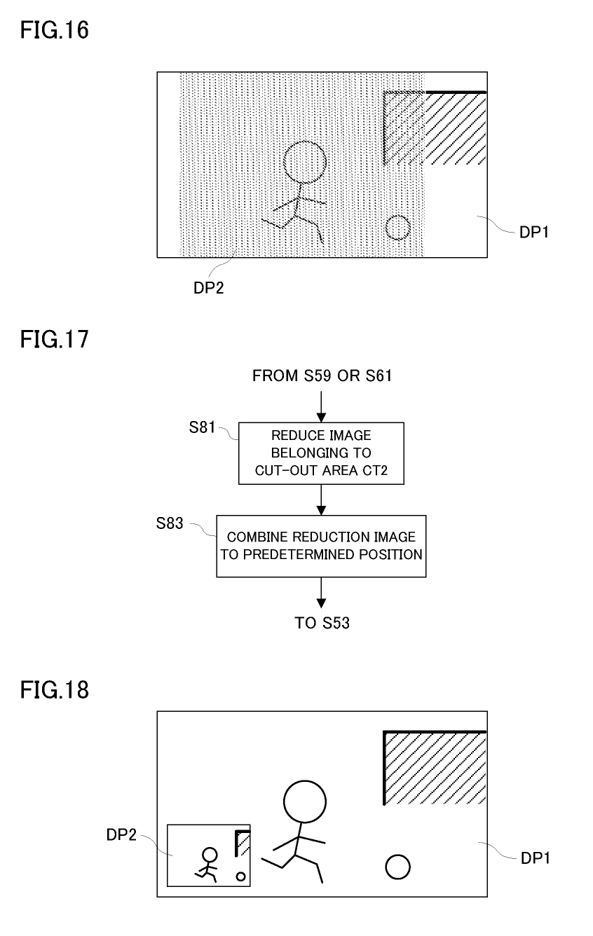

As a result, a through image DP1 based on the image data produced by the post-processing circuit 26 and a through image DP2 based on the image data produced by the post-processing circuit 28 are displayed on the LCD monitor 32 with the same magnification as shown in FIG. 16. Furthermore, a display position of the through image DP2 moves along with the movement of the cut-out area CT2.

The CPU 36 may optionally execute processes in steps S81 to S83 shown in FIG. 17, instead of the step S63 shown in FIG. 13. In the step S81, a predetermined reduction magnification is set to the image combining circuit 52. In the step S83, the predetermined position is set to the image combining circuit 52. As a result, the through image DP2 is fixedly displayed at a lower left of the screen with a magnification smaller than the magnification of the through image DP1 as shown in FIG. 18.

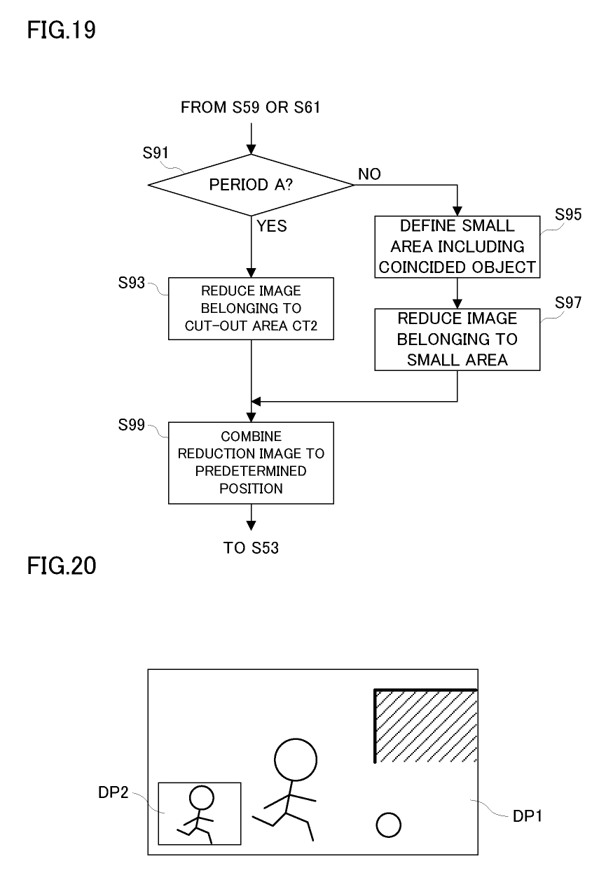

Furthermore, the CPU 36 may optionally execute processes in steps S91 to S99 shown in FIG. 19, instead of the step S63 shown in FIG. 13. In the step S91, it is determined whether a current time belongs to which of the alternately appearing period A or B. When the current time belongs to the period A, the predetermined reduction magnification is set to the image combining circuit 52 in the step S93. When the current time belongs to the period B, the process advances to the step S95 so as to set the position of the small area, in which the object that coincides with the registered object is captured, to the image combining circuit 52. In the step S97, the reduction magnification corresponding to a size of the small area is set to the image combining circuit 52. Upon completion of the process in the step S93 or S97, the predetermined position is set to the image combining circuit 52 in a step S99.

As a result, in the period A, the through images DP1 and DP2 are displayed as shown in FIG. 18. Moreover, in the period B, the through image DP1 and a through image DP3 corresponding to the small area are displayed as shown in FIG. 20.

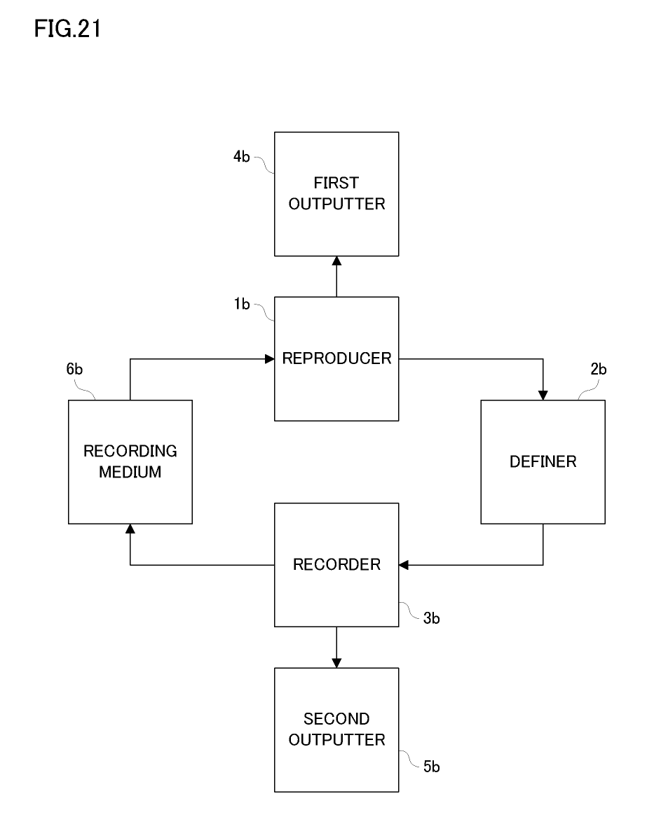

With reference to FIG. 21, the image processing apparatus of a further embodiment of the present invention is basically configured as follows: A reproducer 1b reproduces a first recorded image that has a first angle of view from a recording medium 6b. A definer 2b defines a cut-out area corresponding to a second angle of view on the first recorded image reproduced by the reproducer 1b. A recorder 3b records a second recorded image belonging to the cut-out area defined by the definer 2b, onto a recording medium 6. A first outputter 4b outputs a first display image corresponding to the first recorded image reproduced by the reproducer 1b. A second outputter 5b outputs depiction-range information indicating a depiction range of the second recorded image recorded by the recorder 3b, in parallel with the output process of the first outputter 4b.

The cut-out area is defined on the first recorded image reproduced from the recording medium, and the second recorded image belonging to the defined cut-out area is recorded onto the recording medium. Thereby, a transcording is realized. Moreover, the process for outputting the depiction range information indicating the depiction range of the second recorded image is executed in parallel with the process for outputting the first display image corresponding to the first recorded image. Thereby, it becomes possible to recognize whether or not the transcording is being executed and how the cut-out area is defined on the first recorded image, through the first display image and the depiction-range information. Thus, an operability regarding the transcoding is improved.

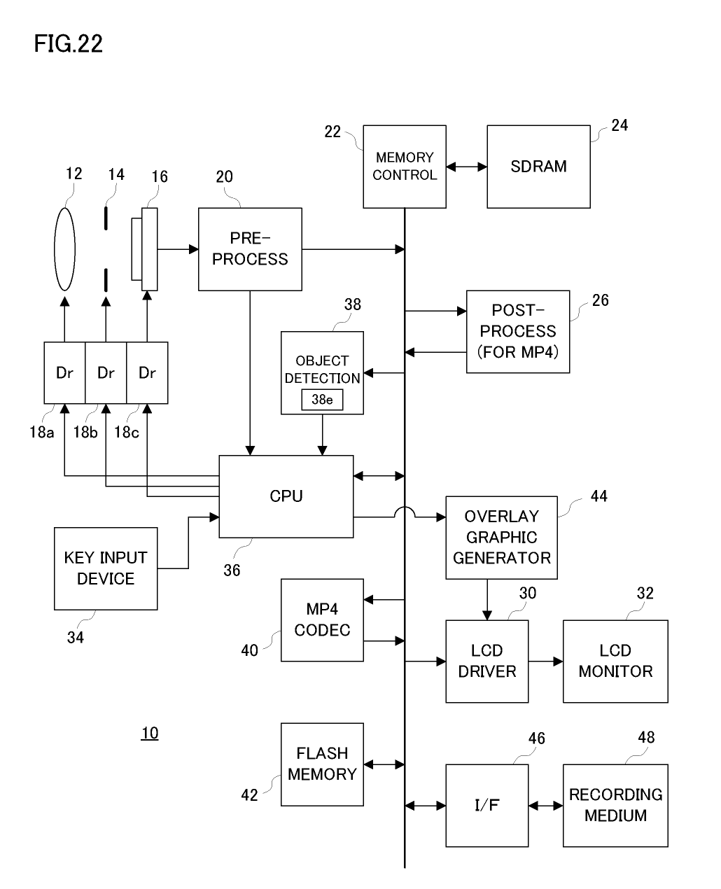

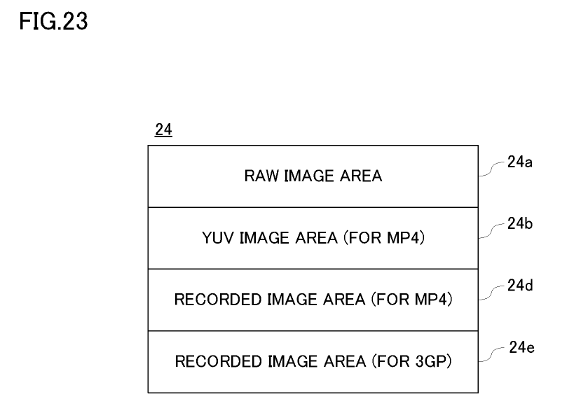

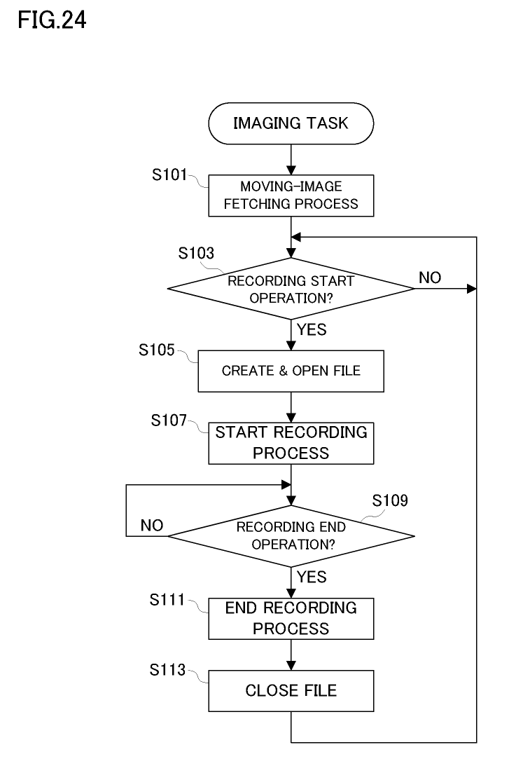

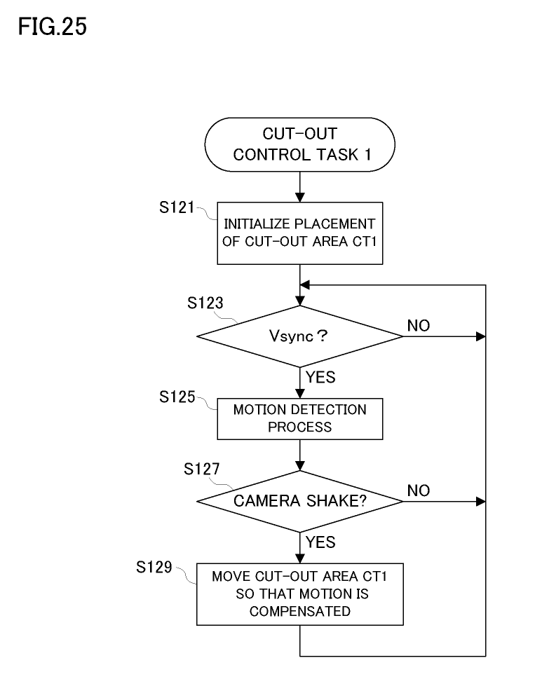

The digital video camera 10 according to a further embodiment differs from that in the embodiment in FIG. 2 in that the post-processing circuit 28 for the 3GP file is omitted as shown in FIG. 22 and the YUV image area 24c for the 3GP file is omitted as shown in FIG. 23. Moreover, an imaging task in FIG. 24 executed by the CPU 36 shown in FIG. 22 and a cut-out control task 1 in FIG. 25 differ from the imaging task shown in FIG. 10 and the cut-out control task 1 shown in FIG. 12 in the following points:

In a step S105 in FIG. 24, out of the MP4 file and the 3GP file, only the MP4 file is created and opened. Furthermore, in a step S107, in order to start the recording process, the MP4 codec 40 and the I/F 46 are started up. Furthermore, the MP4 codec 40 merely writes the compressed image data that is based on the image data in the 1080/60i system accommodated in the YUV image area 24b, into the recorded image area 24d. Also the I/F 46 merely writes the compressed image data accommodated in the recorded image area 24d, into the MP4 file created in the step S105. Ina step S111, the MP4 codec 40 and the I/F 46 are stopped in order to end the recording process. In a step S113, the MP4 file in an opened state is closed. It is noted that the processes in steps S101, S103, and S109 are the same as the processes in the steps S1, S3, and S9.

In the cut-out control task 1 shown in FIG. 25, processes similar to those in the steps S31 to S39 shown in FIG. 12 are executed in steps S121 to S129. Upon completion of the process in the step S129, the process returns to the step S123. That is, in the cut-out control task 1 shown in FIG. 25, processes equivalent to those in the steps S41 to S47 shown in FIG. 12 are omitted.

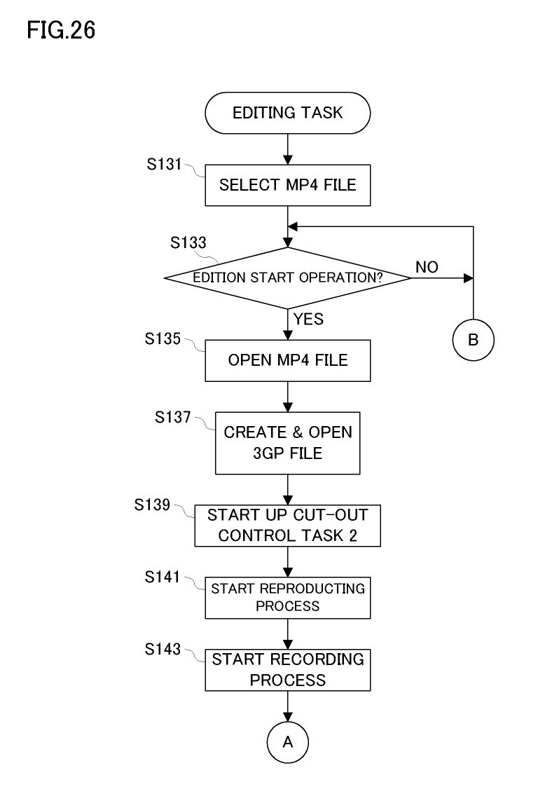

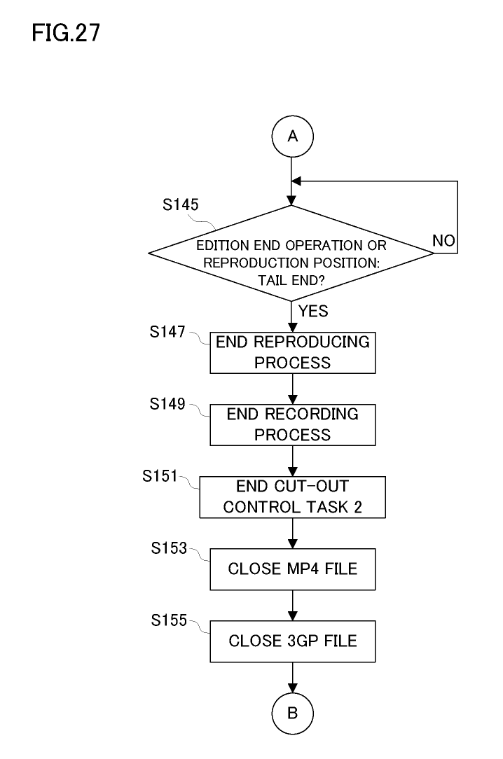

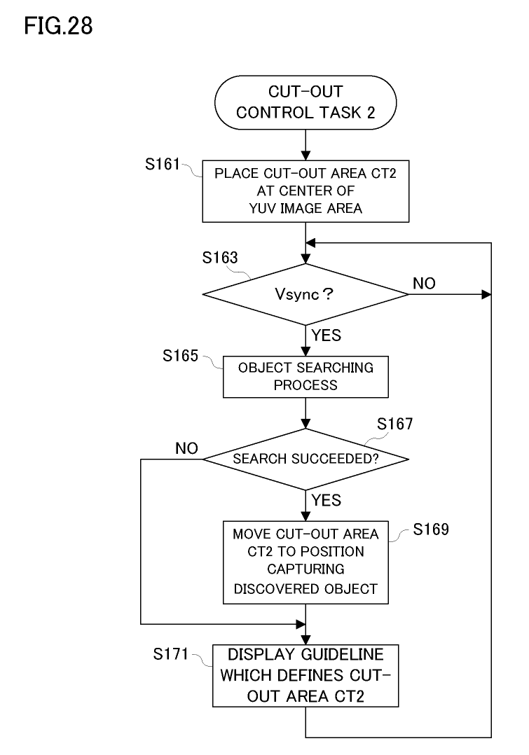

Furthermore, the digital video camera 10 shown in FIG. 22 has an editing mode. If the editing mode is selected by the operation of the key input device 34, then an editing task shown in FIG. 26 and FIG. 27 and a cut-out control task 2 shown in FIG. 28 are executed by the CPU 36 in a parallel manner.

With reference to FIG. 26, in a step S131, any one of one or at least two MP4 files saved on the recording medium 48 is selected as a reproduced MP4 file. In a step S133, it is determined whether or not an edition start operation is performed. When a determined result is updated from NO to YES, the reproduced MP4 file is opened in a step S135. In a step S137, the 3GP file is newly created, and the created 3GP file is opened. In a step S139, the cut-out control task 2 is started up; in a step S141, the reproducing process is started; and in a step S143, the recording process is started.

In the step S141, more particularly, a reproduction start command is applied to the I/F 46 and the MP4 codec 40, and the LCD driver 30 is started up. Moreover, in the step S143, more particularly, a recording start command is applied to the MP4 codec 40 and the I/F 46.

In response to the reproduction command, the I/F 46 reads out the compressed image data from the MP4 file that is in an opened state, and writes the read-out compressed image data into the recorded image area 24d shown in FIG. 23 through the memory control circuit 22. Furthermore, the MP4 codec 40 reads out the compressed image data accommodated in the recorded image area 24d through the memory control circuit 22, decompresses the read-out compressed image data according to the MP4 system, and writes the decompressed image data into the YUV image area 24b shown in FIG. 23 through the memory control circuit 22. The LCD driver 30 reads out the image data thus accommodated in the YUV image area 24b through the memory control circuit 22, and drives the LCD monitor 32 based on the read-out image data. As a result, a reproduced moving image is displayed on the LCD monitor 32.

Moreover, in response to the recording command, the MP4 codec 40 reads out the image data belonging to the cut-out area CT2, out of the image data accommodated in the YUV image area 24b, through the memory control circuit 22, compresses the read-out image data according to the MP4 system, and writes the compressed image data into the recorded image area 24e shown in FIG. 23 through the memory control circuit 22. The I/F 46 reads out the compressed image data accommodated in the recorded image area 24e through the memory control circuit 22, and accommodates the read-out compressed image data into the 3GP file newly created on the recording medium 48.

In a step S145, it is determined whether or not an OR condition that an edition end operation is performed or the reproduction position reaches a tail end of the MP4 file is satisfied. When a determined result is updated from NO to YES, the reproducing process is ended in a step S147; the recording process is ended in a step S149; and the cut-out control task 2 is ended in a step S151.

In the step S147, more particularly, a reproduction end command is applied to the I/F 46 and the MP4 codec 40, and the LCD driver 30 is stopped. Moreover, in the step S149, more particularly, a recording end command is applied to the MP4 codec 40 and the I/F 46. The MP4 file is closed in a step S153, and the 3GP file is closed in a step S155. Upon completion of the process in the step S155, the process returns to the step S133.

With reference to FIG. 28, in a step S161, the cut-out area CT2 is placed at a center of the YUV image area 24b. Thereby, from the center of the image data accommodated in the YUV image area 24b, one portion of the image data equivalent to the cut-out area CT2 is read out. In steps S163 to S171, processes similar to those in the steps S53, and S57 to S63 shown in FIG. 13 are executed.

According to the embodiment, the CPU 36 reproduces the image data that has the angle of view equivalent to the cut-out area CT1 from the MP4 file saved on the recording medium 48 (S141), defines the cut-out area CT2 on the reproduced image data (S161 and S169), and records the image data belonging to the defined cut-out area CT2, into the 3GP file created on the recording medium 48 (S143). The LCD driver 30 displays the reproduced moving image that is based on the image data reproduced from the MP4 file, on the LCD monitor 30. Furthermore, the overlay graphic generator 44 displays the guideline GL1 (i.e., the depiction-range information) defining the cut-out area CT2 (i.e., the depiction range of the image data recorded in the 3GP file) on the LCD monitor 30 in the OSD manner.

The cut-out area CT2 is defined on the image data reproduced from the MP4 file, and the image data belonging to the defined cut-out area CT2 is recorded in the 3GP file. Thereby, a transcording is realized. Furthermore, the process for outputting the depiction-range information indicating the cut-out area CT2 is executed in parallel with the process for outputting the display image that is based on the image data reproduced from the MP4 file. Thereby, it become possible to recognize whether or not the transcoding is being executed and how the cut-out area CT2 is defined on the image data reproduced from the MP4 file, through the display image and the depiction-range information. Thus, an operability regarding the transcoding is improved.

It is noted that in this embodiment also, in order to show the structural outline of the object scene image recorded in the 3GP file, the guideline GL1 is multiplexed onto the through image. However, a reduced through image based on the image data belonging to the cut-out area CT2 may be optionally displayed on the LCD monitor 32 in parallel with the through image that is based on the image data accommodated in the YUV image area 24b.

In this case, instead of the overlay graphic generator 44 shown in FIG. 22, the image combining circuit 52 shown in FIG. 14 is arranged. Moreover, the CPU 36 executes processes in the steps S71 to S73 shown in FIG. 15 instead of the step S171 shown in FIG. 28.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a capturer which captures an original image representing a scene;
a first creator which creates a first recorded image corresponding to a first cut-out area allocated to the scene, based on the original image captured by said capturer;
a second creator which creates based on the original image captured by said capturer a second recorded image corresponding to a second cut-out area having a size that falls below a size of the first cut-out area and being allocated to the scene;
a first outputter which outputs a first display image corresponding to the first recorded image created by said first creator; and
a second outputter which outputs depiction-range information indicating a depiction range of the second recorded image created by said second creator, in parallel with the output process of said first outputter.

2. An image processing apparatus according to claim 1, further comprising:
a searcher which searches a specific object from the first cut-out area based on the original image captured by said capturer; and
an adjuster which adjusts a position of the second cut-out area so that the specific object discovered by said searcher is captured in the second cut-out area.

3. An image processing apparatus according to claim 1, wherein said second outputter includes a graphic image multiplexer which multiplexes, as the depiction-range information, a graphic image representing the second cut-out area onto the first display image outputted by said first outputter.

4. An image processing apparatus according to claim 1, wherein said second outputter includes a second display image multiplexer which multiplexes, as the depiction-range information, the second display image corresponding to the second recorded image created by said second creator onto the first display image outputted by said first outputter.

5. An image processing apparatus according to claim 4, wherein a magnification of the second display image at a time of outputting is equal to a magnification of the first display image at a time of outputting, and said second display image multiplexer multiplexes the second display image onto the first display image corresponding to the position of the second cut-out area.

6. An image processing apparatus according to claim 4, wherein the magnification of the second display image at a time of outputting is smaller than the magnification of the first display image at a time of outputting, and said second display image multiplexer multiplexes the second display image onto a predetermined position on the first display image.

7. An image processing apparatus according to claim 1, further comprising:
a first recorder which encodes and records the first recorded image created by said first creator onto a recording medium; and
a second recorder which encodes and records the second recorded image created by said second creator onto the recording medium.

8. An image processing apparatus according to claim 1, wherein each of the first cut-out area and the second cut-out area is equivalent to a rectangular area, and a vertical size of the second cut-out area is equal to a vertical size of the first cut-out area and a horizontal size of the second cut-out area is smaller than a horizontal size of the first cut-out area.

9. An image processing apparatus according to claim 1, further comprising an imager which captures a scene, wherein said capturer captures, as the original image, the scene image outputted from said imager.

10. An image processing apparatus according to claim 9, further comprising:
a detector which detects a movement of an imaging surface; and
a changer which changes a position of the first cut-out area so that the movement detected by said detector is compensated.

11. An image processing apparatus according to claim 1, wherein said first creator executes a creating process irrespective of an absence or presence of a recording instruction, and said second creator executes the creating process in response to the recording instruction.

12. An image processing apparatus according to claim 1, wherein said first outputter and said second outputter respectively output said first display image and said depiction-range information toward a displayer.

13. An image processing apparatus, comprising:
a reproducer which reproduces a first recorded image that has a first angle of view from a recording medium;
a definer which defines on the first recorded image reproduced by said reproducer a cut-out area corresponding to a second angle of view;
a recorder which records a second recorded image belonging to the cut-out area defined by said definer onto the recording medium;
a first outputter which outputs the first display image corresponding to the first recorded image reproduced by said reproducer; and
a second outputter which outputs depiction-range information indicating a depiction range of the second recorded image recorded by said recorder, in parallel with the output process of said first outputter.

14. An image processing apparatus according to claim 13, wherein said recorder and said first outputter execute a recording process and an output process, respectively, in parallel with the reproducing process of said reproducer.

15. An image processing apparatus according to claim 13, further comprising:
a searcher which searches a specific object from the first recorded image reproduced by said reproducer; and
an adjuster which adjusts a position of the cut-out area so that the specific object discovered by said searcher is captured in the cut-out area.

16. An image processing apparatus according to claim 13, wherein said second outputter includes a graphic image multiplexer which multiplexes, as the depiction-range information, a graphic image representing the cut-out area onto the first display image outputted by said first outputter.

17. An image processing apparatus according to claim 13, wherein said second outputter includes a second display image multiplexer which multiplexes, as the depiction-range information, the second display image corresponding to the second recorded image onto the first display image outputted by said first outputter.

18. An image processing apparatus according to claim 17, wherein a magnification of the second display image at a time of outputting is smaller than a magnification of the first display image at a time of outputting, and said second display image multiplexer multiplexes the second display image onto a predetermined position on the first display image.

19. An image processing apparatus according to claim 13, wherein said first outputter and said second outputter respectively output said first display image and said depiction-range information toward a displayer.
